(19) United States
(12) Patent Application Publication
(10) Pub. No.: US 2012/0163358 A1
(43) Pub. Date: Jun. 28, 2012

(54) END DEVICE AND ROUTING METHOD FOR THE END DEVICE IN WIRELESS SENSOR NETWORK

(75) Inventors: Hoon JEONG, Daejeon (KR); Nae Soo KIM, Daejeon (KR)

(73) Assignee: Electronics and Telecommunications Research Institute, Daejeon (KR)

(21) Appl. No.: 13/335,568

(22) Filed: Dec. 22, 2011

(30) Foreign Application Priority Data
Dec. 22, 2010 (KR) 10-2010-0132509

(51) Int. Cl. H04W 84/12; H04W 40/02

(52) U.S. Cl. 370/338

(57) ABSTRACT

A routing method in a wireless communication network, and more particularly, a method of efficiently routing an end device included in the wireless communication network is provided. The wireless communication network may provide data communications using multiple communication devices, and the communication devices may be defined by standards such as ZigBee, and IEEE 802.15.4.

### CROSS-REFERENCE TO RELATED APPLICATION

This application claims the benefit of Korean Patent Application No. 10-2010-0132509, filed on Dec. 22, 2010, in the Korean Intellectual Property Office, the disclosure of which is incorporated herein by reference.

### BACKGROUND

1. Field of the Invention

The present invention relates to a routing method in a wireless communication network, and more particularly, to a method of efficiently routing for an end device included in a wireless communication network.

2. Description of the Related Art

A wireless communication network provides data communications using multiple communication devices, and the communication devices may be defined by standards such as ZigBee, and IEEE 802.15.4.

For example, according to the ZigBee standards, the communication devices are classified into a Personal Area Network (PAN) coordinator, a router, and an end device. According to the IEEE 802.15.4 standards, the communication devices are classified into a Full Function Device (FFD), and a Reduced Function Device (RFD). The FFD of the IEEE 802.15.4 standards corresponds to the PAN coordinator and the router of the ZigBee standards, and the RFD of the IEEE 802.15.4 standards corresponds to the end device of the ZigBee standards.

Described based on the ZigBee standards, the PAN coordinator generates a single wireless communication network, and the router and the end device accesses the PAN coordinator using a tree topology.

The end device only performs data communication with a parent device of the end device using the tree topology. Accordingly, when the end device transmits data to a destination device, the end device may proceed with the transmission via the parent device only.

That is, the end device transmits the data to the parent device, and the parent device performs routing for the destination device, and thereby the data is transferred from the end device to the destination device.

However, since the end device transmits the data to the parent device of the end device first although the destination device is positioned around the end device, a path for transferring the data may be unnecessarily lengthened.

### SUMMARY

An aspect of the present invention provides an end device and a routing method for the end device in a wireless sensor network, and more particularly, a method of efficiently routing for the end device in order to reduce a data transfer path in a wireless communication network, such as IEEE 802.15.4 and ZigBee.

According to an aspect of the present invention, there is provided a routing method for an end device in a wireless sensor network, the method including maintaining a neighbor information table to store an address of a neighboring device, determining whether a destination address to be transmitted corresponds to an end device, verifying whether at least one of a parent address and an ancestor address of the destination address exists in the neighbor information table when the destination address corresponds to the end device as a result of the determination, and transmitting, to the found address, data to be transmitted when an address is found in the neighbor information table.

When a plurality of addresses is found in the neighbor information table, the transmitting may include transmitting the data to be transmitted, to an address having a depth closest to a depth of the destination address, among the plurality of found addresses.

The routing method may further include sequentially verifying whether at least one of the destination address, the parent address of the destination address, and the ancestor address of the destination address exists in the neighbor information table when the destination address does not correspond to the end device as the result of the determination.

According to another aspect of the present invention, there is also provided a routing apparatus for an end device in a wireless sensor network, the apparatus including a neighbor information table to store an address of a neighboring device, a determination unit to determine whether a destination address to be transmitted corresponds to an end device, a verification unit to verify whether at least one of a parent address and an ancestor address of the destination address exists in the neighbor information table when the destination address corresponds to the end device as a result of the determination, and a transmission unit to transmit, to the found address, data to be transmitted when an address is found in the neighbor information table.

When a plurality of addresses is found in the neighbor information table, the transmission unit may transmit the data to be transmitted, to an address having a depth closest to a depth of the destination address, among the plurality of found addresses.

When the destination address does not correspond to the end device as the result of the determination, the verification unit may sequentially verify whether at least one of the destination address, the parent address of the destination address, and the ancestor address of the destination address exists in the neighbor information table.

According to still another aspect of the present invention, there is also provided a wireless sensor network, including a Personal Area Network (PAN) coordinator to generate a single communication network for the wireless sensor network, at least one router to perform routing of data associated with the communication network, in conjunction with the PAN coordinator, and an end device to access the communication network, and to receive data from a router corresponding to a parent device, among the at least one router. The at least one router may maintain a neighbor information table to store an address of a neighboring device, sequentially search for a parent address or an ancestor address of a destination address in the neighbor information table when the destination address to be transmitted corresponds to the end device, and transmit data to be transmitted, to the address found as a result of the search.

According to a further aspect of the present invention, there is also provided a wireless sensor network, including a PAN coordinator to generate a single communication network for the wireless sensor network, at least one router to perform routing of data associated with the communication network, in conjunction with the PAN coordinator, and an end device to access the communication network to transmit and receive data. The end device may maintain a neighbor information table to store an address of a neighboring device, sequentially search for a parent address or an ancestor address of a destination address in the neighbor information table when the destination address to be transmitted corresponds to the end device, and transmit data to be transmitted, to the address found as a result of the search.

### EFFECT

According to embodiments of the present invention, data may be transmitted through a path faster than an instance when the data is transmitted to an end device, or the end device transmits the data, in a wireless sensor network.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example of a method of allocating an address in a ZigBee-based wireless sensor network according to a conventional art;

FIG. 2 is a diagram illustrating an example of topology that may be generated by the address allocation method of FIG. 1 according to a conventional art;

FIGS. 3 and 4 are diagrams illustrating examples of topologies that may be generated by a routing method for an end device in a wireless sensor network according to an embodiment of the present invention;

FIG. 5 is a diagram illustrating another example of a method of allocating an address in a ZigBee-based wireless sensor network according to a conventional art;

FIGS. 6 and 7 are diagrams illustrating examples of topologies that may be generated by a routing method for an end device in a wireless sensor network according to another embodiment of the present invention; and

FIG. 8 is a diagram illustrating a routing method for an end device in a wireless sensor network according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

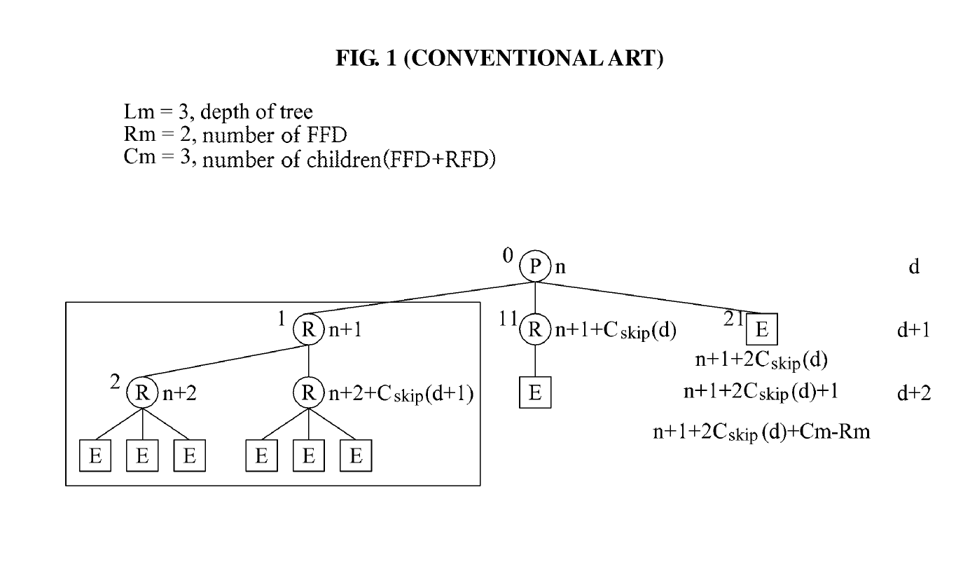

FIG. 1 is a diagram illustrating an example of a method of allocating an address in a ZigBee-based wireless sensor network according to a conventional art.

Referring to FIG. 1, a hierarchical structure of the wireless sensor network is shown. It may be assumed that a depth of tree (Lm) corresponds to 3, a maximum number of routers (Rm) corresponds to 2, and a maximum number of child devices (Cm) corresponds to 3. A value Cskip(d) of the hierarchical structure may be given by Equation 1.

$$Cskip ( d ) = 1 + Cm \cdot ( Lm - d - 1 ) , if Rm = 1 \\ Cskip ( d ) = \frac{1 + Cm - Rm - Cm \cdot {Rm}^{Lm - d - 1}}{1 - Rm} , Rm \neq 1 \qquad [ Equation 1 ]$$

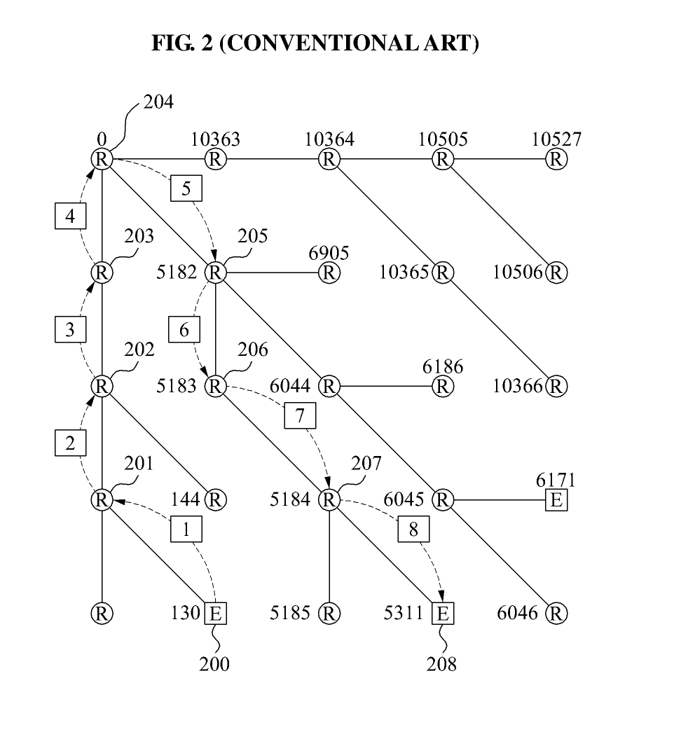

FIG. 2 is a diagram illustrating an example of topology that may be generated by the address allocation method of FIG. 1 according to a conventional art. It may be assumed that a depth of tree (Lm) corresponds to 4, a maximum number of child devices (Cm) corresponds to 20, and a maximum number of routers (Rm) corresponds to 6. Also, a ZigBee standard Cskip address-based tree routing may be performed in the topology.

FIG. 2 illustrates a process of an end device 200 having an address 130 being given by the address allocation method of FIG. 1 may transfer data to another end device 208 having an address 5311.

In this instance, the end device 200 and the end device 208 may be spatially positioned close to each other, however, the end device 200 may only perform transmission and reception with a parent device according to a characteristic of an end device. Routers may be disposed as the parent device and an ancestor device of the end device 200, and the routers may perform a Cskip address-based tree routing. The data transmitted from the end device 200 may be sequentially transferred to a router 201 through a router 207, and may be transferred to the end device 208.

In the wireless sensor network according to an embodiment of the present invention, the end device and the routers may route the data using a neighbor information table to store an address of a neighboring device.

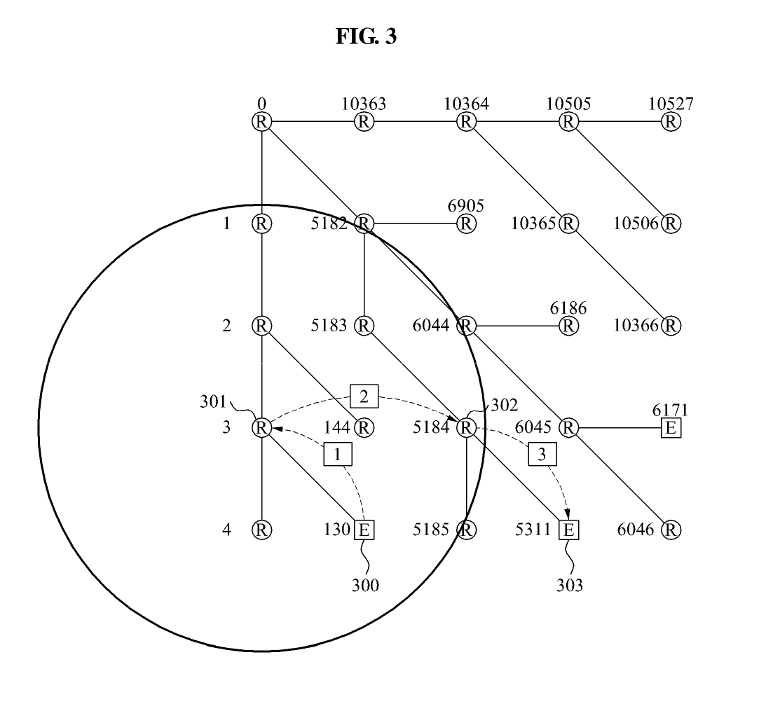

FIG. 3 is a diagram illustrating an example of topology in a routing method for an end device in a wireless sensor network according to an embodiment of the present invention. FIG. 3 illustrates a case in which a router of the wireless sensor network may route data using a neighbor information table.

FIG. 3 illustrates a process in which an end device 300 having an address 130 may transfer data to another end device 303 having an address 5311.

The end device 300 may transfer the data to be transferred to a router 301 corresponding to a parent device of the end device 300. The router 301 may verify whether an address of parent device of the end device 303, or an address of ancestor device of the end device 303 exists in a neighbor information table of the router 301, and may transmit the data to the found address. The data may be transferred to a router 302 corresponding to a parent device of the end device 303 through the transmission, and accordingly the router 302 may transfer the transferred data to the end device 303 having a destination address of the data transmission.

As aforementioned, when a router routes data using a neighbor information table, a routing path shorter than the routing path of FIG. 2 may be available. In particular, in the routing method, the data may be rapidly transferred to a parent device of an end device having a destination address, based on the neighbor information table.

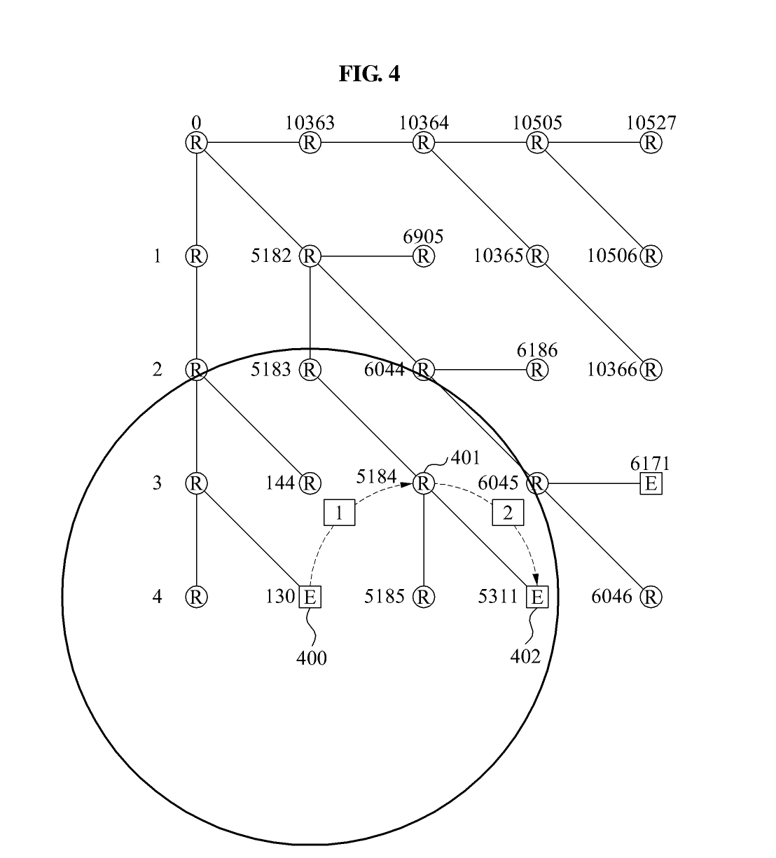

FIG. 4 is a diagram illustrating another example of topology in a routing method for an end device in a wireless sensor network according to another embodiment of the present invention. FIG. 4 illustrates a case in which the end device may use a neighbor information table in the wireless sensor network.

A conventional end device may perform a sleep mode for a low power operation without directly performing routing, and accordingly may transfer data to be transferred, to a parent device that may perform the routing.

However, the end device according to another embodiment of the present invention may access and maintain the neighbor information table indicating an address of a neighboring device, and may directly perform routing of the data based on the neighbor information table.

Also, the end device may receive data from a parent device through a periodical polling operation when entering a sleep mode by a duty cycle according to a characteristic, and may have no limitation due to the sleep mode when the end device transmits the data. Accordingly, when the end device uses neighbor information of the end device, a transfer path may be shortened as illustrated in FIG. 4.

Referring to FIG. 4, when an end device 400 having an address 130 transfers data to an end device 402 having another address 5311, the end device 400 may sequentially search for an address of parent device of the end device 402, or an address of ancestor device of the end device 402 based on a neighbor information table. The end device 400 may transfer the data to the found address. In this instance, a device corresponding to the found address may correspond to a router 401 corresponding to the parent device of the end device 402, the router 401 may transmit, to the end device 402, the data transferred from the end device 400.

Consequently, the end device 400 may more rapidly, in comparison to the case of FIG. 3, transfer the data to the parent device of the destination address, or the end device 402 based on the neighbor information table.

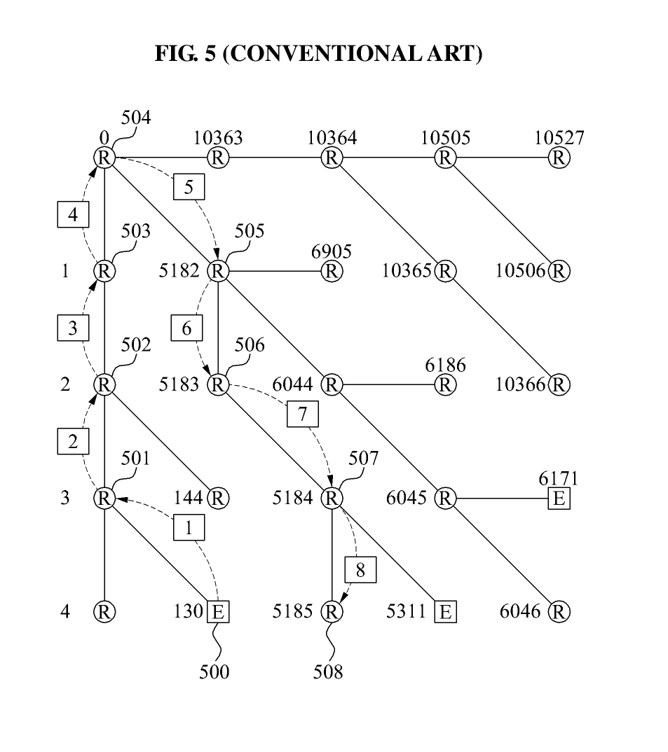

FIG. 5 is a diagram illustrating another example method of allocating an address in a ZigBee-based wireless sensor network according to a conventional art. FIG. 5 illustrates a case in which a Cskip address-based tree routing may be applied to the conventional ZigBee-based wireless sensor network, similar to FIG. 2.

Referring to FIG. 5, when an end device 500 having an address 130 transmits data to a router 508 having an address 5185, the data transmitted from the end device 500 may be sequentially transferred to a router 501 through a router 507, and may be transferred to the router 508.

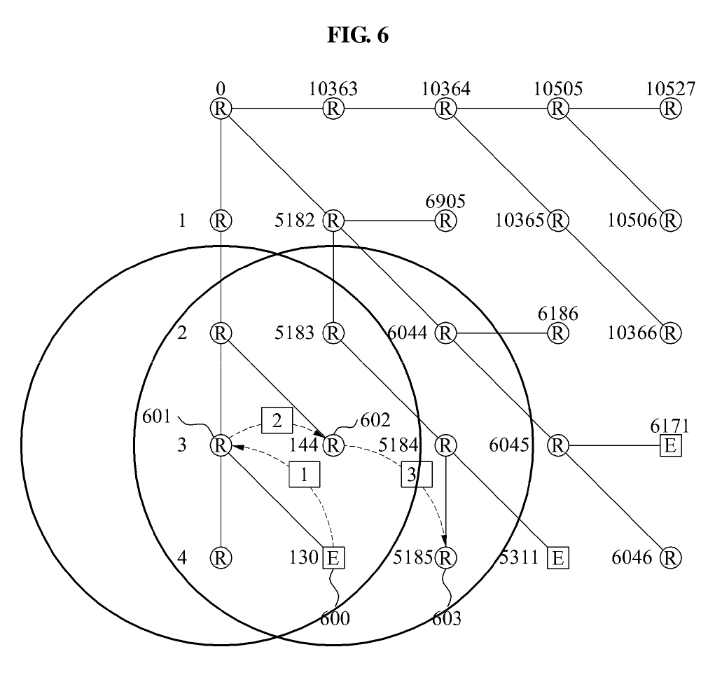

FIG. 6 is a diagram illustrating an example of topology that may be generated by a routing method for an end device in a wireless sensor network according to another embodiment of the present invention. FIG. 6 illustrates a case in which a router may use a neighbor information table, the end device may not perform routing, and a destination address of data may correspond to the router.

Referring to FIG. 6, the end device 600 may transmit data to a router 601 corresponding to a parent device of the end device 600. The router 601 may search for at least one of an address of the router 603, an address of parent device of the router 603, and an address of ancestor device of the router 603, based on a neighbor information table of the router 601, and may transfer the data to a device corresponding to the found address.

In this instance, the device corresponding to the found address may correspond to the parent device of the router 603, and accordingly a router 602 corresponding to the parent device of the router 603 may sequentially search for at least one of the address of the router 603, the address of parent device of the router 603, and the address of ancestor device of the router 603, based on a neighbor information table of the router 602. A device corresponding to the found address may correspond to the router 603, and accordingly, the router 602 may finally transmit the data to the router 603.

As aforementioned, when a router routes data based on a neighbor information table, the data may be transferred more rapidly in comparison to the tree routing scheme of FIG. 5.

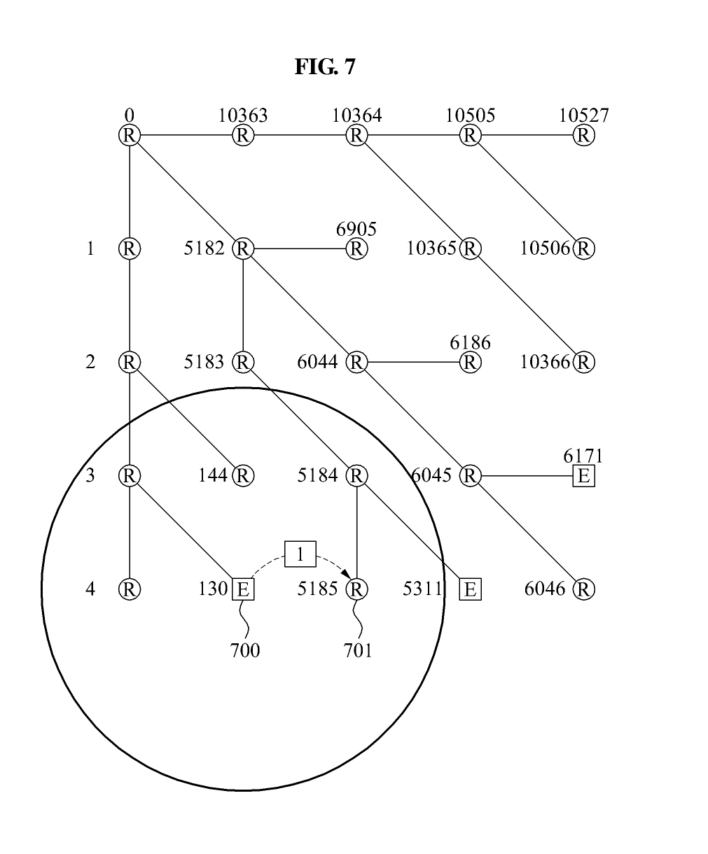

FIG. 7 is a diagram illustrating another example of topology that may be generated by a routing method for an end device in a wireless sensor network according to another embodiment of the present invention. FIG. 7 illustrates a case in which the end device may perform routing using a neighbor information table, and a destination address of data may correspond to a router.

Referring to FIG. 7, an end device 700 having an address 130 may verify whether a destination address 5185 of the data, a parent address of the destination address 5185, and an ancestor address of the destination address 5185 exists, based on a neighbor information table. The end device 700 may transmit the data to the found address.

Accordingly, the end device 700 may transfer the data to a router 701 having the destination address of 5185 more rapidly in comparison to the case of FIG. 6.

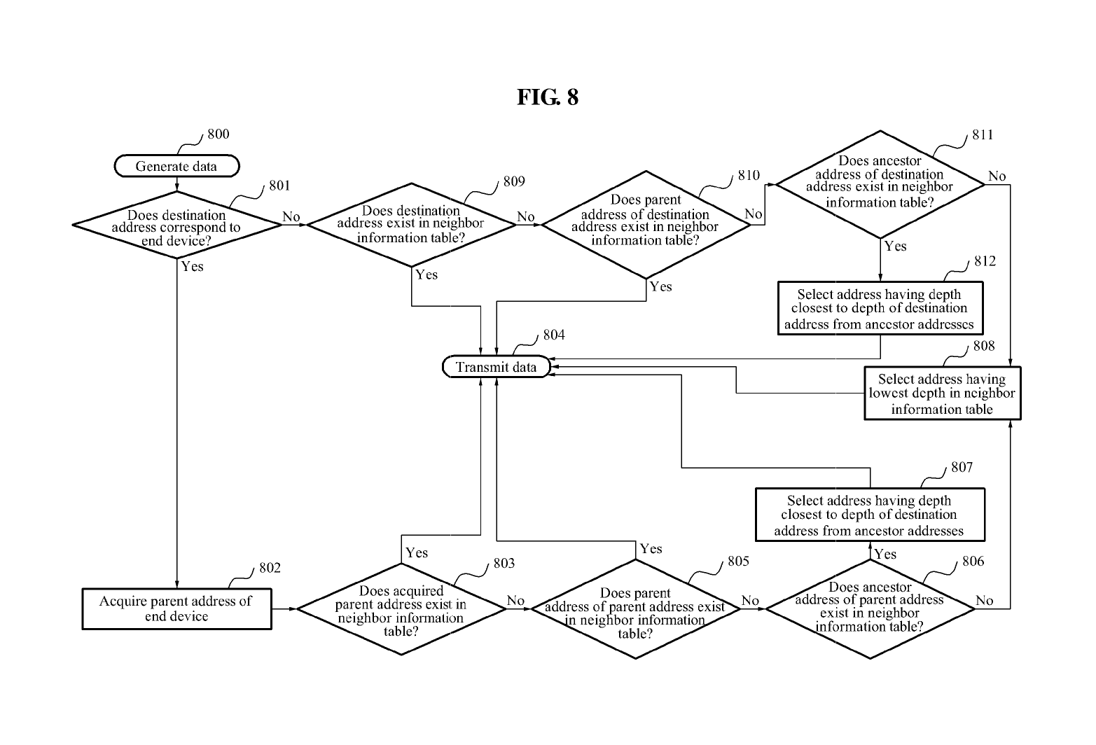

FIG. 8 is a diagram illustrating a routing method for an end device in a wireless sensor network according to an embodiment of the present invention. Data transmission in the wireless sensor network may be initiated by a Personal Area Network (PAN) coordinator, a router, or an end device, and a destination of the data transmission may correspond to the router or the end device (*an/another router or an/another end device). Also, routing of the data may be applied by the router or the end device. Accordingly, the following operations, from operation 801 to operation 809, may be performed by the router or the end device performing the routing.

Referring to FIG. 8, in operation 801, whether a destination address of data transmission corresponds to an end device may be determined.

When the destination address is determined to correspond to the end device as a result of the determination in operation 801, an address of parent device of the end device having the destination address, hereinafter referred to as a ‘parent address’, may be acquired in operation 802.

In operation 803, whether the acquired parent address exists in a neighbor information table may be verified.

When the parent address is found in the neighbor information table as a result of the verification in operation 803, the data may be transmitted to the found parent address in operation 804.

When the parent address is absent in the neighbor information table as a result of the verification in operation 803, whether a parent address of the parent address exists in the neighbor information table may be verified in operation 805.

When the parent address of the parent address is found in the neighbor information table in operation 805, the data may be transmitted to the parent address of the parent address in operation 804. However, when the parent address of the parent address is absent in the neighbor information table in operation 805, whether an ancestor address of the parent address exists in the neighbor information table may be verified in operation 806.

When a plurality of ancestor addresses is found in the neighbor information table as a result of the verification in operation 806, an address having a depth closest to a depth of the destination address may be selected from the plurality of found addresses in operation 807. When an address is selected in operation 807, the data may be transmitted to the selected address, in operation 804.

When the ancestor address is not found in the neighbor information table as a result of the verification in operation 806, the data may be transmitted to an address having a lowest depth in the neighbor information table, in operation 808.

When the destination address does not correspond to the end device as a result of the determination in operation 801, whether the destination address exists in the neighbor information table may be verified in operation 809.

When the destination address is found in the neighbor information table in operation 809, the data may be transmitted to the destination address in operation 804. However, when the destination address is absent in the neighbor information table in operation 809, whether a parent address of the destination address exists in the neighbor information table may be verified in operation 810.

When the parent address is found in operation 810, the data may be transmitted to the found parent address in operation 804. However, when the parent address is not found in operation 810, whether an ancestor address of the destination address exists in the neighbor information table may be verified in operation 811.

When a plurality of ancestor addresses is found in the neighbor information table as a result of the verification in operation 811, an address having a depth closest to a depth of the destination address may be selected from the plurality of found addresses, in operation 812. In operation 804, the data may be transmitted to the address selected in operation 812.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A routing method for an end device in a local area wireless sensor network, the method comprising:
maintaining a neighbor information table to store an address of a neighboring device;
determining whether a destination address to be transmitted corresponds to an end device;
verifying whether at least one of a parent address and an ancestor address of the destination address exists in the neighbor information table when the destination address corresponds to the end device as a result of the determination; and
transmitting, to the found address, data to be transmitted when an address is found in the neighbor information table.

2. The method of claim 1, wherein, when a plurality of addresses is found in the neighbor information table, the transmitting comprises transmitting the data to be transmitted, to an address having a depth closest to a depth of the destination address, among the plurality of found addresses.

3. The method of claim 1, further comprising:
sequentially verifying whether at least one of the destination address, the parent address of the destination address, and the ancestor address of the destination address exists in the neighbor information table when the destination address does not correspond to the end device as a result of the determination.

4. A routing apparatus for an end device in a wireless sensor network, the apparatus comprising:
a neighbor information table to store an address of a neighboring device;
a determination unit to determine whether a destination address to be transmitted corresponds to an end device;
a verification unit to verify whether at least one of a parent address and an ancestor address of the destination address exists in the neighbor information table when the destination address corresponds to the end device as a result of the determination; and
a transmission unit to transmit, to the found address, data to be transmitted when an address is found in the neighbor information table.

5. The apparatus of claim 4, wherein, when a plurality of addresses is found in the neighbor information table, the transmission unit transmits the data to be transmitted, to an address having a depth closest to a depth of the destination address, among the plurality of found addresses.

6. The apparatus of claim 4, wherein the verification unit sequentially verifies whether at least one of the destination address, the parent address of the destination address, and the ancestor address of the destination address exists in the neighbor information table when the destination address does not correspond to the end device as a result of the determination.

7. A wireless sensor network, comprising:
a Personal Area Network (PAN) coordinator to generate a single communication network for the wireless sensor network;
at least one router to perform routing of data associated with the communication network, in conjunction with the PAN coordinator; and
an end device to access the communication network, and to receive data from a router corresponding to a parent device, among the at least one router,
wherein the at least one router maintains a neighbor information table to store an address of a neighboring device, sequentially searches for a parent address or an ancestor address of a destination address in the neighbor information table when the destination address to be transmitted corresponds to the end device, and transmits data to be transmitted, to the address found as a result of the search.

8. A wireless sensor network, comprising:
a Personal Area Network (PAN) coordinator to generate a single communication network for the wireless sensor network;
at least one router to perform routing of data associated with the communication network, in conjunction with the PAN coordinator; and
an end device to access the communication network to transmit and receive data,
wherein the end device maintains a neighbor information table to store an address of a neighbor device, sequentially searches for a parent address or an ancestor address of a destination address in the neighbor information table when the destination address to be transmitted corresponds to the end device, and transmits data to be transmitted, to the address found as a result of the search.
